(19) United States
(12) Patent Application Publication
(10) Pub. No.: US 2007/0210012 A1
(43) Pub. Date: Sep. 13, 2007

(54) WET SOLIDS REMOVAL AND SEPARATION SYSTEM

(75) Inventors: Darren D. Schmidt, Thompson, ND (US); Kyle E. Martin, Grand Forks, ND (US)

Correspondence Address: CONLEY ROSE, P.C.;David A. Rose, P. O. BOX 3267, HOUSTON, TX, 77253-3267, US

(73) Assignee: ENERGY & ENVIRONMENTAL RESEARCH CENTER FOUNDATION, Grand Forks, ND (US)

(21) Appl. No.: 11/683,599

(22) Filed: Mar. 8, 2007

Related U.S. Application Data
(60) Provisional application No. 60/780,705, filed on Mar. 9, 2006.

(51) Int. Cl. C02F 1/00

(52) U.S. Cl. 210/767

(57) ABSTRACT

A system comprising a slurry trap including a trap inlet and a trap outlet. In addition, the system comprises a slurry tank including a slurry inlet and a slurry outlet. The slurry inlet of the slurry tank is in fluid communication with the trap outlet. Further, the system comprises a separator including a slurry inlet in fluid communication with the slurry outlet of the slurry tank.

### CROSS-REFERENCE TO RELATED APPLICATIONS

This application claims benefit of U.S. provisional application Ser. No. 60/780,705 filed Mar. 9, 2006, and entitled “Wet Solids Removal and Separation System,” which is hereby incorporated herein by reference in its entirety.

### STATEMENT REGARDING FEDERALLY SPONSORED RESEARCH OR DEVELOPMENT

Not applicable.

### BACKGROUND

1. Field of the Invention

The present disclosure relates generally to apparatus and methods for the removal and separation of wet solids from combustion and gasification devices. More specifically, the present disclosure relates to apparatus and methods for the removal and separation of wet solids from biomass gasifiers.

2. Background of the Invention

Energy conversion devices (e.g., boilers, combustors, gasifiers) designed to convert solid fuels into energy or other forms of fuel are numerous and generally known in the art. For example, coal-fired boilers are commonly used in the utility industry to convert coal into electricity, and gasifiers are commonly used in the petroleum-refining industry to convert hydrocarbons into a low-Btu gas.

More generally, the process of converting a carbonaceous material such as coal, petroleum, petroleum coke, or biomass into a low-Btu “syngas” consisting primarily of hydrogen, carbon monoxide, methane, carbon dioxide, and nitrogen is often referred to as “gasification.” The breakdown of the carbonaceous fuel into the desirable syngas is done by carefully controlling the amount of oxygen present while heating the carbonaceous fuel to extreme temperatures. However, the gasification process also results in less desirable secondary products consisting primarily of spent fuel solids, typically in the form of ash and charcoal. In particular, biomass gasifiers employ the gasification process to convert carbonaceous fuels such as wood chips, agricultural residues, and process wastes into syngas and spent fuel solids.

As the gasification process proceeds, it may be desirable to remove the hot, dry, dusty spent fuel solids from the gasifier, similar to the manner in which bottom ash is removed from a furnace. A variety of techniques have been developed to remove spent fuel solids from a gasifier. However, most conventional spent fuel solids removal systems include one or more disadvantages. For instance, some conventional gasifiers employ a dry removal system. As the name implies, dry removal systems are intended to remove the spent fuel solids in their dry form. However, since a significant portion of spent fuel solids consist of fine particulate matter, many dry removal systems lead to dust problems. For example, in a dry removal process, very fine spent fuel dust may be “kicked up” at the slightest disturbance, possibly going airborne and mixing with the desirable syngas product.

In some conventional spent fuel solids removal systems, the gasifier may not be coupled to the removal system in an airtight manner. Such systems may undesirably permit the entry of air into the gasifier and/or permit the uncontrolled escape of the desirable syngas product from the gasifier during spent fuel removal. Since the gasification process requires careful control over the amount of oxygen present while heating the carbonaceous materials, the uncontrolled entry of air into the gasifier during the spent fuel removal process may detrimentally impact the gasification process and products. For example, uncontrolled entry of air into a gasification process may lead to spontaneous ignition of spent charcoal. Further, any uncontrolled escape and loss of the desirable syngas during spent fuel removal tends to detrimentally reduce syngas yields.

Moreover, many conventional spent fuel solids removal systems employ a relatively large infrastructure that may include a host of complex mechanical subsystems such as conveyor belts, auger systems, etc. Because of their size and complexity, such systems may be impractical, inappropriate, and/or cost prohibitive for relatively small-scale and/or remote biomass gasification operations. For instance, relatively small biomass operations conducted at sawmills, wood-processing facilities, secondary processing facilities utilizing waste products as biomass fuel, etc., may not have the space or financial resources for such large complex systems.

Still further, many conventional spent fuel solids removal systems employ environmentally unsound procedures. For example, some conventional removal systems simply move the potentially hazardous spent fuel solids away from the gasifier and dump the spent fuel solids into the environment. In some cases, the spent fuel solids may percolate through the soil into a freshwater supply or resource.

Accordingly, there remains a need in the art for methods, apparatus, and systems that effectively remove spent fuel solids from combustors and gasifiers, which overcome some of the foregoing difficulties while providing more advantageous overall results.

### SUMMARY OF THE PREFERRED EMBODIMENTS

In accordance with at least one embodiment, a system for removing spent fuel solids from a slurry comprises a slurry trap including a trap inlet and a trap outlet. The trap inlet is operable to receive a liquid and the trap outlet is operable to flow a slurry comprising the liquid and one or more spent fuel solids out of the slurry trap. In addition, the system comprises a slurry tank including a slurry inlet and a slurry outlet. The slurry inlet of the slurry tank is in fluid communication with the trap outlet and is operable to receive the slurry from the trap outlet. Further, the system comprises a separator including a slurry inlet in fluid communication with the slurry outlet of the slurry tank. The separator is operable to substantially separate the one or more spent fuel solids and the liquid in the slurry.

In accordance with another embodiment, a system for removing spent fuel solids from a slurry comprises a gasifier operable to gasify a solid fuel to produce a syngas and one or more spent fuel solids. In addition, the system comprises a slurry trap comprising a trap outlet. The slurry trap is coupled to the gasifier and operable to receive the one or more spent fuel solids from the gasifier. Further, the system comprises a first tank comprising a first tank inlet and a first tank outlet. The first tank inlet is in fluid communication with the trap outlet. Still further, the system comprises a separator including a separator inlet. The separator inlet is in fluid communication with the first tank outlet. The separator is operable to separate the one or more spent fuel solids from the slurry.

In accordance with another embodiment, a method for removing spent fuel solids from a slurry comprises receiving one or more spent fuel solids into a slurry trap. In addition, the method comprises flowing a liquid through the slurry trap. Further, the method comprises mixing the liquid at least partially with the spent fuel solids in the slurry trap to form a slurry. Still further, the method comprises flowing the slurry from the slurry trap to a separator. The separator separates the slurry into a sludge and the liquid, the liquid being substantially free of spent fuel solids.

Thus, embodiments described herein comprise a combination of features and advantages intended to address various shortcomings associated with certain prior devices. The various characteristics described above, as well as other features, will be readily apparent to those skilled in the art upon reading the following detailed description of the preferred embodiments and by referring to the accompanying drawings.

### BRIEF DESCRIPTION OF THE DRAWINGS

For a detailed description of the preferred embodiments of the invention, reference will now be made to the accompanying drawings in which:

FIG. 1 is a schematic side view of an embodiment of a wet solids removal and separation system constructed in accordance with the principles described herein; and

FIG. 2 is a schematic side view of another embodiment of a wet solids removal and separation system constructed in accordance with the principles described herein.

### DETAILED DESCRIPTION OF THE PREFERRED EMBODIMENTS

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in the interest of clarity and conciseness.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection, or through an indirect connection via other devices and connections. Further, the term “syngas” refers to a product of the combustion or gasification process comprising primarily hydrogen, carbon monoxide, methane, carbon dioxide, and nitrogen.

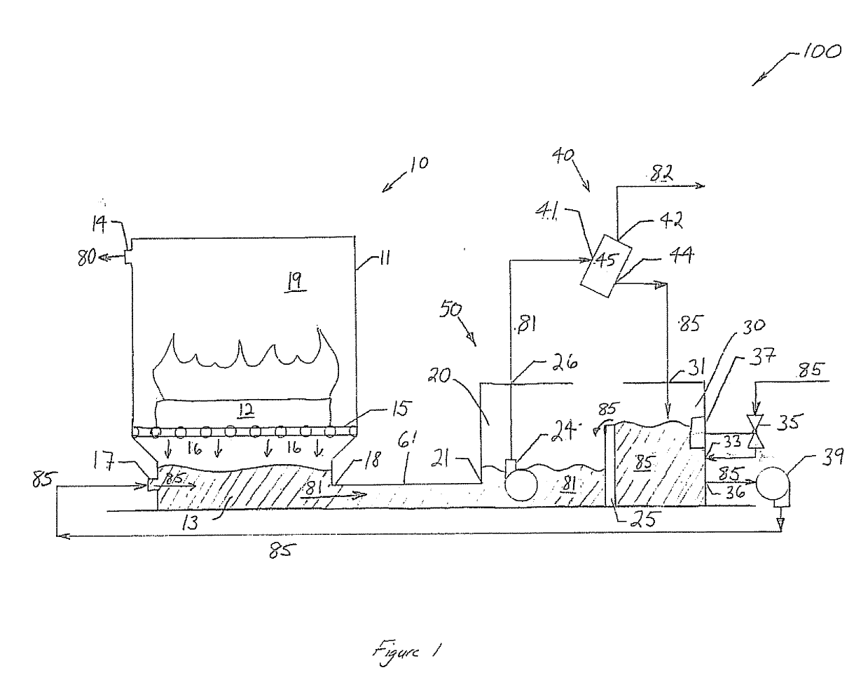

Referring now to FIG. 1, an embodiment of a solids removal and separation system 100 is schematically illustrated. System 100 comprises a gasifier 10, a separation tank 50, and a separator 40.

In general, gasifier 10 is configured to consume fuel 12 in a gasification process. Gasifier 10 includes a gasifier body 11 having an inner gasification chamber 19. A gas outlet 14 for the desirable syngas 80 produced by the gasification process is provided in gasifier body 11. Fuel 12 is supported within chamber 19 by a fuel support 15. In particular, fuel support 15 holds fuel 12 above a slurry trap 13. However, fuel support 15 permits spent fuel solids 16 from the gasification process to pass therethrough, and into slurry trap 13 below. In the embodiment shown in FIG. 1, fuel support 15 is a grate including holes or gaps (not shown) that permit spent fuel solids 16 to pass therethrough when spent fuel solids 16 reach a particular size. However, in general, fuel support 15 may comprise any suitable device capable of separating spent fuel solids 16 (e.g., ash, charcoal, etc.) from the solid fuel 12. Examples of suitable devices include, without limitation, a grate, a screen structure, a moving screen conveyor belt, and combinations thereof. It should be appreciated that one may control the size of spent fuel solids 16 that pass through fuel support 15 by varying the size of the holes or gaps in fuel support 15. Fuel 12 may comprise any suitable fuel for a gasification or combustion process including, without limitation, coal, petroleum, petroleum coke, biomass (e.g., wood chips, agricultural residues, process wastes, etc.), and combinations thereof.

As described above, slurry trap 13 is provided below fuel support 15 to capture spent fuel solids 16 from gasifier 10. Slurry trap 13 includes a trap inlet 17 and a trap outlet 18. As will be explained in more detail below, slurry trap 13 is in fluid communication with a separation tank 50 via trap outlet 18 and a conduit 61.

In use, fuel 12 is gasified within chamber 19 of gasifier 10. Through the gasification process, fuel 12 is converted into spent fuel solids 16 (e.g., composed primarily of ash and charcoal) and desirable syngas 80, comprising primarily hydrogen, carbon monoxide, methane, carbon dioxide, and nitrogen. The produced syngas 80 exits gasifier 10 at gas outlet 14, and may be stored, used, processed, transported to another location, etc. Once spent fuel solids 16 attain a particular size, spent fuel solids 16 fall under the force of gravity through fuel support 15 and into a spent fuel removal liquid 85 generally flowing through slurry trap 13 from trap inlet 17 to trap outlet 18. Liquid 85 provides a “wet” means to quench the hot, dry spent fuel solids 16 and remove spent fuel solids 16 from gasifier 10, thereby offering the potential to reduce some of problems caused by fine dust in spent fuel solids 16. Because of the relatively low cost, availability, and quenching capabilities of water, liquid 85 is preferably water or a water mixture.

As spent fuel solids 16 are added to, and mix with, liquid 85, liquid 85 becomes a slurry 81. Thus, slurry 81 is primarily a mixture of spent fuel solids 16 and liquid 85. Slurry 81 exits slurry trap 13 at trap outlet 18 and flows through conduit 61 to separation tank 50 for further processing. It is to be understood that additional liquid 85 enters slurry trap 13 via trap inlet 17 as slurry 81 exits slurry tank 13. In this manner, liquid 85, which transitions into slurry 81 as spent fuel solids 16 are added thereto, is continuously flowing through slurry trap 13. In some embodiments, an agitator or other device (not shown) is provided in slurry tank 13 to deter the settling out of spent fuel solids 16 from slurry 81.

Referring still to FIG. 1, separation tank 50 comprises a first tank 20, a second tank 30, and a divider 25 that physically separates first tank 20 from second tank 30. In general, first tank 20 holds slurry 81 and second tank 30 holds liquid 85. Thus, first tank 20 may also be referred to herein as a “slurry tank,” and second tank 30 may also be referred to herein as a “clean liquid tank,” the term “clean” indicating that spent fuel solids 16 have been substantially removed from liquid 85 held in second tank 30. Divider 25 restricts the commingling of slurry 81 held in slurry tank 20 and liquid 85 held in clean liquid tank 30.

First tank 20 includes a first tank inlet 21, a first pump 24, and a first tank outlet 26. Since first tank 20 is intended to hold slurry 81, first tank inlet 21, first pump 24, and first tank outlet 26 may also be referred to herein as a “slurry inlet”, a “slurry pump”, and a “slurry outlet”, respectively. In some embodiments, an agitator or other device (not shown) is also provided in first tank 20 to deter the settling out of spent fuel solids 16 from slurry 81.

First tank 20 is in fluid communication with slurry trap 13 and a separator 40. Slurry 81 exits slurry trap 13 through trap outlet 18, and flows to first tank 20 via first tank inlet 21. Further, slurry 81 in first tank 20 is pumped by first tank pump 24 from first tank 20 through first tank outlet 26 to separator 40.

Separator 40 comprises a separation device 45, a separator inlet 41, a first separator outlet 42, and a second separator outlet 44. Separator 40 is in fluid communication with first tank 20 and second tank 30. Slurry 81 is pumped by first pump 24 from first tank 20 through first tank outlet 26 to separator inlet 41. Slurry 81, composed primarily of spent fuel solids 16 (e.g., ash, charcoal, etc.) and liquid 85, flows through separation device 45 where slurry 81 is separated into a sludge 82 and liquid 85. Sludge 82 is a concentrated mixture of spent fuel solids 16 with some liquid 85. The separated “clean” liquid 85 is substantially free of spent fuel solids 16.

In general, separation device 45 may comprise any suitable device capable of separating solids (e.g., ash, charcoal) from a slurry. Examples of suitable separators include without limitation, a filtering device, a backflush filter, a centrifuge, and the like. Further, in some embodiments, more than one separator may be employed to further enhance the separation of spent fuel solids 16 from slurry 81.

The use of separation device 45 to separate spent fuel solids 16 from slurry 81, and to concentrate and remove spent fuel solids 16 from system 100 in the form of sludge 82, offers the potential for an environmentally friendly system 100. For example, by concentrating spent fuel solids 16 into sludge 82, the volume of waste is reduced.

Referring still to FIG. 1, sludge 82 exits separation device 45 at first separator outlet 42. Thus, first separator outlet 42 may also be referred to herein as a “sludge outlet”. After exiting separation device 45, sludge 82 may be further processed (e.g., dry pressed into charcoal briquettes, further separated), stored, burned (e.g., conveyed to a thermal oxidizer to be burned off) or otherwise disposed of (e.g., discharged to a waste or sewer line). Liquid 85 exits separation device 45 at second separator outlet 44 and flows to second tank 30. Thus, second separator outlet 44 may also be referred to herein as a “liquid outlet” or a “clean liquid outlet.” The separated liquid 85 that exits separation device 45 is preferably substantially free of spent fuel solids 16, but may contain small amounts of spent fuel solids 16 that were not separated out by separator 40. In this manner, spent fuel solids 16 (e.g., charcoal, ash, etc.) in slurry 81 exit system 100 in the form of a concentrated sludge 82, while a majority of liquid 85 contained in slurry 81 is separated from slurry 81 and returns to system 100 for further use. It should be appreciated that some quantities of liquid 85 may leave system 100 as part of sludge 82.

Second tank 30 comprises a second tank inlet 31, a control device 37, a fresh fluid inlet 33, and a second tank outlet 36. Since second tank 30 is intended to hold “clean” liquid 85, second tank inlet 31 and second tank outlet 36 may also be referred to herein as a “clean liquid inlet” and a “clean liquid outlet”, respectively. Second tank 30 is in fluid communication with separator 40 such that separated liquid 85 flows from second separator outlet 44 of separator 40 into second tank 30 via second tank inlet 31. In addition, second tank 30 is in fluid communication with slurry trap 13 such that liquid 85 may be pumped by a second or “clean” liquid pump 39 from second tank 30 to slurry trap 13 via second tank outlet 36 and trap inlet 17. In this manner, second tank 30 supplies liquid 85 to slurry trap 13 so that additional spent fuel solids 16 may be carried away and ultimately removed from system 100 in the form of sludge 82. In this manner, liquid 85 is recycled and recirculated through system 100.

By recycling liquid 85, embodiments of system 100 offer the potential for additional environmental benefits. For example, if liquid 85 is water, by recycling the water rather than providing a continuous flow of fresh water to system 100, less fresh water will be used by system 100. Further, by recycling liquid 85, embodiments of system 100 offer the potential for a more versatile solids removal and separation system. For example, if liquid 85 is water, by recycling the water rather than providing a continuous flow of fresh water to system 100, a large freshwater supply may not be necessary to sufficiently conduct the gasification removal process. This may be particularly advantageous in locations where a large, ready supply of fresh fluid (e.g., water) may not be available.

Referring still to FIG. 1, it should be appreciated that open space is provided between first tank 20 and second tank 30 above divider 25. Thus, depending on the level of liquid 85 in second tank 30, some liquid 85 may spill over divider 25 into first tank 20; likewise, depending on the level of slurry 81 in the first tank 20, some slurry 81 may spill over the divider 25 into the second tank 30. For reasons explained in more detail below, in some instances, it may be advantageous for some liquid 85 in second tank 30 to spill over divider 25 into first tank 20, thereby increasing the volume and height of slurry 81 in first tank 20. However, in general, slurry 81 in first tank 20 is preferably restricted from rising above divider 25 and flowing into liquid 85 in second tank 30. In particular, if slurry 81 in first tank 20 does flow into the liquid 85 in second tank 30, liquid 85 in second tank 30 will become contaminated with spent fuel solids 16 contained in slurry 81 and be recirculated through the entire system 100 without first passing through separator 40. Thus, in this embodiment, system 100 includes a control device 37 that regulates the addition of fresh liquid 85 into second tank 30 and system 100.

In the embodiment shown in FIG. 1, control device 37 controls a valve 35 that regulates the timing and amount of fresh liquid 85 added to second tank 30. In general, fresh liquid 85 may be added second tank 30 in order to maintain a sufficient volume of fluid within system 100. For instance, fresh liquid 85 maybe added to second tank 30 to replace a portion of or all of liquid 85 that left system 100 at separator 40 as part of sludge 82. Thus, by controlling the input of fresh liquid 85 into the system, control device 37 helps to regulate the volume and height of liquid 85 within second tank 30, the volume and height of slurry 81 within first tank 20, and the volume of fluid in system 100. In some embodiments, control device 37 may comprise a float valve that controls the inlet of fresh liquid 85. In addition to control device 37, the relative speeds of pumps 24, 39 may also be controlled and adjusted, as necessary, to control the levels of slurry 81 in first tank 20 and liquid 85 in second tank 30.

In the manner described, spent fuel solids 16 are continuously removed from system 100. Spent fuel solids 16 fall into “clean” liquid 85 flowing into slurry trap 13, thereby forming a slurry 81 that flows to first tank 20. Slurry 81 is pumped from first tank 20 through separator 40, which removes spent fuel solids 16 from slurry 81 in the form of sludge 82 that is discharged from system 100. Further, any liquid 85 remaining after spent fuel solids 16 have been separated from slurry 81 is returned to second tank 30 for reuse. “Clean” separated liquid 85 within second tank 30 is then recycled back to slurry trap 13 to continue the process.

As previously discussed, the control of conditions within chamber 19 is important to conducting a successful gasification process. In particular, the addition of air, oxygen in particular, to chamber 19 may detrimentally affect the gasification process. For example, an influx of air into chamber 19 may lead to spontaneous combustion and a complete burning of fuel 12, as opposed to a controlled gasification process. Further, since syngas 80 is the desirable product of the gasification process in chamber 19, syngas 80 is preferably restricted from escaping chamber 19 by any means other than through syngas outlet 14. For at least these reasons, a gas-tight seal (e.g., an airtight seal) is preferably maintained at trap outlet 18 of slurry trap 13. By maintaining a gas-tight seal at trap outlet 18, air is restricted from entering chamber 19 via trap outlet 18, and further, syngas 80 is restricted from escaping through trap outlet 18.

In the embodiment of solids removal and separation system 100 shown in FIG. 1, a gas-tight seal at trap outlet 18 is maintained by controlling the volume of fluid (e.g., liquid 85 and slurry 81) within system 100, and more particularly, by controlling the volume and height of fluid within slurry trap 13 and conduit 61. For example, by keeping conduit 61 completely filled with slurry 81, gas (e.g., air) is restricted from entering chamber 19 via trap outlet 18, and further, gas (e.g., syngas) is restricted from escaping chamber 19 via trap outlet 18. For the reasons described above, such a gas tight seal at trap outlet 18 is preferably maintained without undesirably contaminating “clean” liquid 85. In other words, the level of slurry 81 in first tank 20 is preferably maintained at a high enough level to completely fill conduit 61, but not so high that slurry 81 spills over divider 25 into “clean” liquid 85 in second tank 30.

As discussed above, the overall volume of fluid (e.g., liquid 85 and slurry 81) within system 100 may be controlled by control device 37. For instance, control device 37 may include a sensor that senses the level of liquid 85 within second tank 30 such that if the level falls below a certain threshold, control device 37 may open valve 35, thereby allowing fresh liquid 85 to be added to system 100. In addition, the levels of liquid 85 in second tank 30 and slurry 81 in first tank 20 may be controlled by adjusting the relative speeds, and hence flowrates, of first pump 24 and second pump 39. For example, in an embodiment, first pump 24 is operated at a higher flow rate than second pump 39. In such an embodiment, more liquid 85 is provided to second tank 30 than second pump 39 removes from second tank 30. Thus, the level of liquid 85 within second tank 30 will continue to rise until it overflows divider 25. Further, the volume and level of slurry 81 in first tank 20 will tend to fall as more slurry 81 is removed from first tank 20 by first pump 24 than is provided to first tank 20 via slurry trap 13 and conduit 61. However, once the level of liquid 85 exceeds the height of divider 25, it may begin overflowing divider 25 and flow into first tank 20, thereby sufficiently counteracting the reduction in volume and level of slurry 81 in first tank 20. In such an embodiment, the volume and level of slurry 81 in first tank 20, conduit 61, and slurry trap 13, is sufficiently maintained to form a gas tight seal at trap outlet 18 without contaminating liquid 85 with slurry 81. Any liquid 85 that overflows divider 25 into first tank 20 will simply be re-processed through separator 40 before being pumped back to slurry trap 13.

It should be appreciated that second pump 39 could be operated at a higher speed and flow rate than first pump 24 to maintain a gas tight seal at trap outlet 18. In such an embodiment, second pump 39 will pump liquid 85 through slurry trap 13 faster than slurry 81 was pumped from first tank 20 to separator 40. As a result, slurry 81 will back up in first tank 20 and the level of slurry in first tank 20 will rise. Although this will enable the level of slurry in first tank 20 to be sufficiently high to maintain an air tight seal at slurry trap outlet 18, it may also undesirably result in the overflow of slurry 81 from first tank 20 into the “clean” liquid 85 in second tank 30.

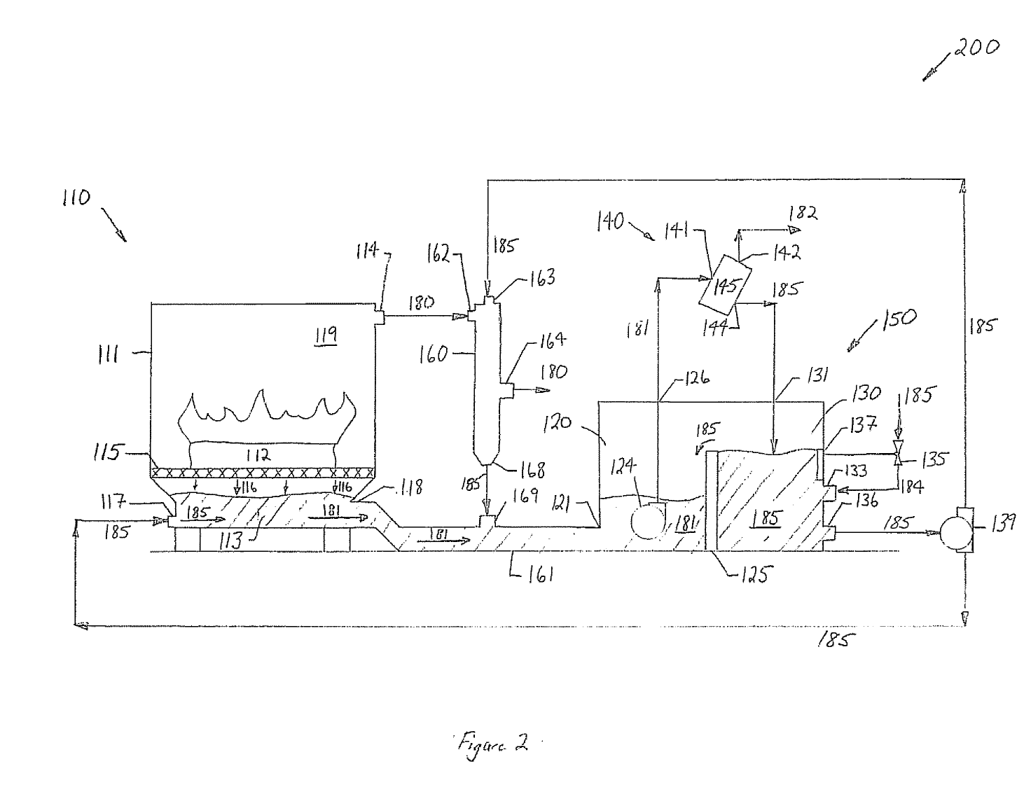

Referring now to FIG. 2, another embodiment of a solids removal and separation system 200 is schematically illustrated. System 200 comprises a gasifier 110, a separation tank 150, and a separator 140. As will be explained in more detail below, system 200 is substantially the same as system 100 previously described, except that system 200 further includes a scrubber 160 and associated structures.

Gasifier 110 comprises a gasifier body 111 having an inner gasification cavity or chamber 119 and a slurry trap 113 below chamber 119. Gasifier body 111 also includes a gas outlet 114 for produced syngas 180. Gas outlet 114 is in fluid communication with a scrubber 160 that is coupled to gasifier 110 and in fluid communication with chamber 119.

Solid fuel 112 for the gasification process is supported within chamber 119 by a fuel support 115. During the gasification process, solid fuel 112 within chamber 119 is converted into desirable syngas 180 and spent fuel solids 116. Fuel support 115 is configured to allow spent fuel solids 116 (e.g., ash, charcoal, etc.) to pass therethrough and into slurry trap 113 below. In this embodiment, fuel support 115 is a screen mesh that supports solid fuel 112, but also includes perforations (not shown) permitting spent fuel solids 116 to pass therethrough when spent fuel solids 116 reach a particular size (e.g., particles of spent fuel solids 116 attain a size smaller than the perforations provided in fuel support 1115).

Slurry trap 113 includes a trap inlet 117 and a trap outlet 118. Spent fuel solids removal liquid 185 flows into slurry trap 113 via trap inlet 117, and slurry 181, comprising a mixture of liquid 185 and spent fuel solids 116, exits slurry trap 113 at trap outlet 118. Trap inlet 117 is in fluid communication with a second tank 130 that holds “clean” liquid 185. Trap outlet 118 is in fluid communication with a first tank 120 that holds slurry 181.

In use, fuel 112 is gasified (or combusted) within chamber 119 of gasifier 110. Through the gasification process, fuel 112 is converted into spent fuel solids 116, composed primarily of ash and charcoal, and desirable syngas 180, composed primarily of hydrogen, carbon monoxide, methane, carbon dioxide, and nitrogen. The produced syngas 180 exits gasifier 110 through gas outlet 114 and proceeds to scrubber 160. Spent fuel solids 116 pass through fuel support 115 under the force of gravity into slurry trap 113 and mixes with liquid 185, which is continuously flowing through slurry trap 113. As spent fuel solids 116 mixes with liquid 185 in slurry trap 113, liquid 185 becomes slurry 181. Slurry 181 exits slurry trap 113 at trap outlet 118 and flows through a conduit 161 to first tank 120 of separation tank 150. Liquid 185 is preferably substantially water, but may alternatively comprise other liquids or ingredients.

Separation tank 150 comprises a first tank 120, a second tank 130, and a divider 125 that physically separates first tank 120 from second tank 130. In general, first tank 120 holds slurry 181 and second tank 130 holds liquid 185. Divider 125 deters the commingling of slurry 181 held in first tank 120 and “clean” liquid 185 held in second tank 130.

First tank 120 comprises a first tank inlet 121, a first pump 124, and a first tank outlet 126. Slurry 181 passes from slurry trap 113 through trap outlet 118, through first tank inlet 121 into first tank 120. From first tank 120, slurry 181 is pumped by first pump 124 through first tank outlet 126 to separator 140.

Separator 140 comprises a separator inlet 141, a separation device 145, a first separator outlet 142, and a second separator outlet 144. Slurry 181 is pumped from first tank 120 through first tank outlet 126, through separator inlet 141 into separation device 145. Within separation device 145, slurry 181 is separated into a sludge 182 and liquid 185. Sludge 182 is composed primarily of spent fuel solids 116, but may contain some liquid 185. Thus, sludge 182 is a more concentrated mixture of spent fuel solids 116 and liquid 185 than slurry 181. Sludge 182 exits separation device 145 through first separator outlet 142. After exiting separation device 145, sludge 182 may be further processed. “Clean” liquid 185 (i.e., liquid 185 that has been substantially separated from spent fuel solids 116) exits separation device 145 through second separator outlet 144 and flows to second tank 130 for continued use in system 200.

Second tank 130 comprises a second tank inlet 131, a control device 137, a fresh liquid inlet 133, and a second tank outlet 136. “Clean” liquid 185 flows from separation device 145 through second separator outlet 144, through second tank inlet 131, and into second tank 130. A portion of liquid 185 in second tank 130 is pumped by second pump 139 through second tank outlet 136, through trap inlet 117, and into slurry trap 113. In addition, a portion of liquid 185 in second tank 130 is pumped by second pump 139 to scrubber 160. In this manner, liquid 185 is continuously flowed and through system 200. In each pass through system 200, liquid 185 picks up spent fuel solids 116 at slurry trap 113, spent fuel solids 116 are substantially separated and removed from liquid 185 by separator 140, and “clean” liquid 185 that is substantially free of spent fuel solids 116, is returned to slurry trap 113 to pick up spent fuel solids 116.

Depending on the relative levels of slurry 181 in first tank 120 and liquid 185 in second tank 130, some liquid 185 or slurry 181 may pass over divider 125 into first tank 120 or second tank 130, respectively. To aid in maintaining an air tight seal at slurry trap outlet 118, while minimizing the risk of contamination of “clean” liquid 185 in second tank 130, liquid 185 in second tank 130 may be permitted to pass over divider 125 into first tank 120. However, slurry 181 in first tank 120 is preferably restricted from passing over divider 125 into second tank 130. To this end, in some embodiments, first pump 124 is operated at a higher speed and flow rate than second pump 139. In such embodiments, more separated and “clean” liquid 185 is returned to second tank 130 from separator 140 than exits second tank 130 through second tank outlet 136. Any excess liquid 185 in second tank 130 that exceeds the height of divider 125 will pass over divider 125 into first tank 120. In this manner, liquid 185 will overflow into first tank 120 at about the same flow rate as the difference between first pump 124 and second pump 139. Consequently, first tank 120 will have substantially the same volume of slurry 181 even though first pump 124 is operating at a higher flow rate than second pump 139; the flow rate of slurry 181 out of first tank 120 in excess of the flow rate of liquid 185 out of second tank 130 is replenished by liquid 185 that passes over divider 125 into first tank 120.

Referring still to FIG. 2, control device 137 regulates the addition of fresh liquid 185 into second tank 130 and system 200. Specifically, in this embodiment, control device 137 controls a valve 135 that regulates the timing and amount of fresh liquid 185 added to second tank 130. In general, fresh liquid 185 may be added second tank 130 in order to maintain a sufficient total volume of fluid (e.g., liquid 185 and slurry 181) within system 200. For instance, fresh liquid 185 maybe added to second tank 130 to replace some or all of the liquid 185 that left system 200 at separator 140 as part of sludge 182.

Although a majority of the spent fuel solids 116 produced by the gasification process are captured and removed via slurry trap 113, some very fine particulate spent fuel solids (e.g., ash, dust, etc.) may become airborne and mix with the desirable syngas 180. However, in this embodiment, a scrubber 160 is provided to remove at least some of this undesirable airborne particulate matter from the produced syngas 180.

Scrubber 160 comprises a gas inlet 162, a scrubber fluid inlet 163, a scrubber gas outlet 180, and a scrubber fluid outlet 168. Produced syngas 180 flows through gas outlet 114 of gasifier 110 and into scrubber 160 via gas inlet 162. Recycled liquid 185 pumped by second pump 139 from second tank 130 enters scrubber 160 via fluid inlet 163. Within scrubber 160, some of the airborne particulate solids in syngas 180 may be removed from syngas 180 and captured by liquid 185 via conventional scrubber techniques. For example, some particulate solids in syngas 180 may be captured by liquid 185 as syngas 180 and liquid 185 flow in contact with each other in scrubber 160. After capturing some particulate solids from syngas 180, “dirty” liquid 185 (i.e., liquid 185 containing amounts of spent fuel particulate matter) exits scrubber 160 through scrubber fluid outlet 168 and joins slurry 181 in conduit 161. Following the removal of some of the particulate solids from syngas 180 in scrubber 160, the relatively “cleaner” syngas 180 exits system 200 through scrubber gas outlet 164. The “clean” Syngas 180 passing through scrubber gas outlet 164 may then be stored, used, processed, transported to another location, etc.

In the manner described, spent fuel solids 116 is continuously removed from system 200. In particular, spent fuel solids 116 is separated from slurry 181 and removed from system 200 by separator 140. In addition, some of the fine particulate matter (e.g., ash, dust, etc.) in syngas 180 is removed from syngas 180 by scrubber 160. Separator 140 removes spent fuel solids 116 from the slurry 181 as sludge 182 that is discharged from system 200. Further, the relatively “cleaner” liquid 185 remaining after spent fuel solids 116 has been removed from slurry 181 is returned to second tank 130 for reuse. A portion of liquid 185 in second tank 130 is then re-circulated back to slurry trap 113, and a portion of liquid 185 in second tank 130 is passed to scrubber 160 to remove particulate spent fuel solids from syngas 180.

For at least the reasons discussed above, the control and maintenance of conditions within chamber 119 are important to conducting a successful gasification process. Thus, it is desirable to maintain a gas tight seal at trap outlet 118 of slurry trap 113. By maintaining a gas tight seal at trap outlet 118, air is prevented from entering chamber 119 via trap outlet 118, and further, syngas 180 may not be lost by escaping through trap outlet 118. By controlling the overall volume of fluid (e.g., liquid 185 and slurry 181) within system 200 such a gas tight seal may be maintained. The overall volume of fluid in system 200 may be controlled by control device 137, which regulates the addition of fresh fluid 185 to system 200. For instance, control device 137 may include a sensor that senses the level of liquid 185 within second tank 130 such that if the level falls below a certain threshold, control device 137 may open valve 135, thereby allowing fresh liquid 85 to be added to system 200.

In addition, by controlling the speed and flow rate of first pump 124 and second pump 139, such a gas tight seal at trap outlet 118 may be maintained without compromising the ability to separate and remove spent fuel solids 116 from system 200. For example, in an embodiment, first pump 124 is operated at a higher flow rate than second pump 139. In such an embodiment, more liquid 185 is provided to second tank 130 than second pump 139 removes from second tank 130. Thus, the level of liquid 185 within second tank 130 will continue to rise until it overflows divider 125. Further, the volume and level of slurry 181 in first tank 120 will tend to fall as more slurry 181 is removed from first tank 120 by first pump 124 than is provided to first tank 120 via slurry trap 113 and conduit 161. However, once the level of liquid 185 exceeds the height of divider 125, it will overflow divider 125 into first tank 120, thereby sufficiently counteracting the reduction in volume and level of slurry 181 in first tank 120. Thus, in such embodiments, the volume and level of slurry 181 in first tank 120, and hence in conduit 161 and slurry trap 113, may be adequately maintained to form a gas tight seal at trap outlet 118 without contaminating liquid 185 with slurry 181. Any liquid 185 that overflows divider 125 into first tank 120 will simply be re-processed through separator 140 before being pumped back to slurry trap 113.

In the embodiments described above, a fluid (e.g., liquid 185) is continuously flowed through the wet solids removal and separation system (e.g., system 200) to remove spent fuel solids from a gasifier (e.g., gasifier 110). In preferred embodiments, water is used as the fluid. However, depending on a variety of factors including without limitation, availability of a fresh water source, environmental conditions (e.g., temperature, etc.), and combinations thereof, an alternative fluid may be used and recycled in embodiments of the present invention. For instance, if an embodiment of the solids removal and separation system (e.g., system 200) is used in a relatively cold environment (e.g., below freezing), a glycol-based fluid may be used to avoid potential problems that may be caused by freezing.

Although the fresh liquid (e.g., fresh liquid 85, 185) is shown being added to the clean liquid tank (e.g., second tank 30, 130) in the systems described above (e.g., systems 100 and 200), it should be appreciated that the fresh liquid may be introduced into system at any suitable location including without limitation, at the slurry trap (e.g., slurry trap 113), at the slurry tank (e.g., first tank 120), at the separator (e.g., separator 140), and combinations thereof. Further, in some embodiments (not illustrated), more than one fresh liquid inlet may be provided in the system.

The pumps described herein (e.g., pumps 24, 39) may comprise any suitable pump including without limitation, sump pumps, centrifugal pumps, electric pumps, and the like. Further, each pump may be of the same type or of different types. Still further, although two pumps are shown in the embodiments of FIGS. 1 and 2, in other embodiments, any number of pumps may be employed in the system to promote the flow of fluids (e.g., slurry 181, liquid 185).

In certain embodiments, one or more pressure control devices (e.g., a valve, choke, pump) may be provided on one or more of the outlets and/or inlets of the system. For example, a valve may be provided on the syngas outlet to adjust and control the flow of syngas from the combustor/gasifier. Further, in select embodiments, a sensor may be associated with one or more inlets and/or outlets to monitor any suitable parameter including without limitation, flow rates, fluid levels, pressure, fluid composition, and combinations thereof. For example, in an embodiment, a sensor may be provided on the syngas outlet to measure the syngas flow rate and syngas quality (e.g., composition of syngas 80). The measurements may be monitored and used to adjust the system for optimal performance.

The various components of wet solids removal and separation systems 100, 200 described herein may be modular or integral units. For instance, in some embodiments, the components of the system (e.g., gasifier, separation tank, separator) may be physically separated, shipped individually, and assembled at the location of the gasification operation.

In the manner described, embodiments described herein may be employed to remove spent fuel solids and fine particulate matter from a gasifier or combustor. In particular, some embodiments provide a “wet” removal system, thereby offering the potential to reduce dust-related issues commonly confronted by “dry” removal systems. Further, some embodiments employ a recycled fluid technique, thereby offering the potential to reduce environmental impacts and reliance on fresh fluid supplies. Still further, embodiments described herein provide a gas tight seal to the gasifier, thereby offering the potential to reduce undesirable entry of air into the combustor or gasifier, and also offering the potential to reduce the undesirable escape of syngas. Moreover, by simplifying the removal and separation process, and eliminating relatively large components (e.g., conveyor belt systems, augers, large separation tanks, etc.), some embodiments described herein may provide a robust, relatively simple, cost effective, and relatively compact spent fuel removal and separation system for use in small scale and/or remote gasifier operations.

While preferred embodiments have been shown and described, modifications thereof can be made by one skilled in the art without departing from the scope or teachings herein. The embodiments described herein are exemplary only and are not limiting. For instance, although the embodiments described herein disclose spent fuel solids removal and separation systems for use with a gasifier, it should be appreciated that the systems disclosed may equally be used to remove and separate spent fuel solids from a combustor or other similar device. Many variations and modifications of the system and apparatus are possible and are within the scope of the invention. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims.

What is claimed is:

1. A system for removing spent fuel solids from a slurry comprising:
a slurry trap including a trap inlet and a trap outlet, wherein the trap inlet is operable to receive a liquid and the trap outlet is operable to flow a slurry comprising the liquid and one or more spent fuel solids out of the slurry trap;
a slurry tank comprising a slurry inlet and a slurry outlet, wherein the slurry inlet of the slurry tank is in fluid communication with the trap outlet and is operable to receive the slurry from the trap outlet; and
a separator comprising a slurry inlet in fluid communication with the slurry outlet of the slurry tank, wherein the separator is operable to substantially separate the one or more spent fuel solids and the liquid in the slurry.

2. The system of claim 1 further comprising a gasifier coupled to the slurry trap, wherein the gasifier includes a gasification chamber in fluid communication with the slurry trap.

3. The system of claim 2 wherein the gasifier is integral with the slurry trap.

4. The system of claim 2 further comprising a slurry pump operable to pump the slurry from the slurry tank to the slurry inlet of the separator.

5. The system of claim 4 wherein the separator further comprises a sludge outlet and a liquid outlet.

6. The system of claim 5 further comprising a liquid tank including a liquid inlet in fluid communication with the liquid outlet of the separator.

7. The system of claim 6 wherein the liquid tank further comprises a control device and a fresh liquid inlet, wherein the control device is operable to control the inlet of fresh liquid into the liquid tank.

8. The system of claim 6 wherein the liquid tank further comprises a liquid outlet in fluid communication with the slurry trap inlet.

9. The system of claim 8 further comprising a liquid pump operable to pump the liquid from the liquid outlet of the liquid tank to the slurry trap inlet.

10. The system of claim 9, wherein the slurry pump is operated at a higher flow rate than the liquid pump.

11. The system of claim 1 further comprising a gas tight seal at the slurry trap outlet.

12. The system of claim 8 wherein the gasifier further comprises a gas outlet operable to flow a syngas produced by the gasifier.

13. The system of claim 12 further comprising a scrubber including a gas inlet in fluid communication with the gas outlet of the gasifier, a liquid inlet in fluid communication with the liquid outlet of the liquid tank, and a gas outlet, wherein the scrubber is operable to remove at least a portion of an airborne spent fuel solid from the syngas.

14. The system of claim 13 wherein the liquid pump is operable to pump the liquid from the liquid tank to the scrubber.

15. The system of claim 1 wherein the separator further comprises a filter operable to substantially separate the slurry into the one or more spent fuel solids and the liquid.

16. The system of claim 1 further comprising a combustor coupled to the slurry trap, wherein the combustor is operable to combust a solid fuel to produce a gas and the one or more spent fuel solids.

17. An system for removing spent fuel solids from a slurry comprising:
a gasifier operable to gasify a solid fuel to produce a syngas and one or more spent fuel solids;
a slurry trap comprising a trap outlet, wherein the slurry trap is coupled to the gasifier and operable to receive the one or more spent fuel solids from the gasifier;
a first tank comprising a first tank inlet and a first tank outlet, wherein the first tank inlet is in fluid communication with the trap outlet; and
a separator comprising a separator inlet, wherein the separator inlet is in fluid communication with the first tank outlet, and wherein the separator is operable to separate the one or more spent fuel solids from the slurry.

18. The system of claim 17 further comprising a first pump operable to pump the slurry from the first tank through the first tank outlet to the separator inlet.

19. The system of claim 18 wherein the separator further comprises a first separator outlet and a second separator outlet.

20. The system of claim 19 further comprising a second tank including a second tank inlet and a second tank outlet, wherein the second tank inlet is in fluid communication with the second separator outlet.

21. The system of claim 20 wherein the slurry trap further comprises a trap inlet, wherein the trap inlet is in fluid communication with the second tank outlet.

22. The system of claim 21 further comprising a second pump operable to pump the liquid from the second tank outlet to the trap inlet.

23. The system of claim 17 wherein a gas tight seal is maintained at the trap outlet.

24. A method for removing spent fuel solids from a slurry comprising:
receiving one or more spent fuel solids into a slurry trap;
flowing a liquid through the slurry trap;
mixing the liquid at least partially with the spent fuel solids in the slurry trap to form a slurry; and
flowing the slurry from the slurry trap to a separator, wherein the separator separates the slurry into a sludge and the liquid, the liquid being substantially free of spent fuel solids.

25. The method of claim 24 further comprising gasifying a fuel to produce a syngas and the spent fuel solids.

26. The method of claim 24 further comprising flowing the liquid from the separator to the slurry trap.

27. The method of claim 22, wherein the slurry trap comprises a trap outlet, wherein the slurry flows from the slurry trap through the trap outlet to the separator.

28. The method of claim 27 further comprising maintaining a gas tight seal at the trap outlet.

29. The method of claim 22, wherein the separator comprises a filter that separates the slurry into the sludge and the fluid.

30. The method of claim 24 further comprising returning the separated liquid from the separator to the slurry trap.

31. The method of claim 30 further comprising pumping the slurry from the slurry trap to the separator with a slurry pump.

32. The method of claim 31 further comprising pumping the separated liquid from the separator to the slurry trap with a liquid pump.

33. The method of claim 32 further comprising operating the slurry pump is operated at a higher flow rate than the liquid pump.
